(19) United States
(12) Patent Application Publication
(10) Pub. No.: US 2017/0295018 A1
(43) Pub. Date: Oct. 12, 2017

(54) SYSTEM AND METHOD FOR SECURING PRIVILEGED ACCESS TO AN ELECTRONIC DEVICE

(71) Applicant: Adtran, Inc., Huntsville, AL (US)

(72) Inventor: John Malcolm Whitehouse, Union Grove, AL (US)

(21) Appl. No.: 15/094,210

(22) Filed: Apr. 8, 2016

(51) Int. Cl. H04L 9/32; H04L 9/08; H04L 29/06

(52) U.S. Cl. CPC H04L 9/321; H04L 63/10; H04L 63/0428; H04L 63/08; H04L 9/088; H04L 63/0209

(57) ABSTRACT

When a user requests root-level access to a device, the device generates a random public and private key pair and encrypts the public key into a request message using a remote server's public key. The encrypted request message is transmitted to the server. The server decrypts the request message using the server's private key. The server encrypts an enable code into a response message using the device's public key. The encrypted response message is transmitted to the device. The device decrypts the response message containing the enable code using the device's private key. The device then enables root-level access using the enable code.

### BACKGROUND

A Local Area Network (LAN) comprises one or more network infrastructure devices, such as switches, routers, gateways, firewalls, servers, wireless access points, multiplexers, passive optical network terminals, etc., interconnected within a building or other premises by cables, such as Ethernet cables. Network administrators or similar personnel are charged with tasks that may include installing network infrastructure devices in the LAN, as well as maintaining and upgrading installed network infrastructure devices. A first step in the process of installing a network infrastructure device in a LAN can be to configure the device. To configure such a device, the network administrator commonly connects a computer, such as a conventional laptop computer, directly to the device with a cable. The computer can have a connection to the Internet and enable the administrator to control the loading of software and configuration information into the device from the computer. The administrator can also perform diagnostic procedures on the device using computer.

An administrator also can configure a device by selectively enabling features. A feature, in the context of a computing device or similar device operating under the control of software, is a distinct or distinguishing characteristic of the device's operation. It is common for commercially available application software to include a set of application features of which only a subset are initially enabled (e.g., by default) at the time the software is initially installed in the device. Thereafter, an administrator can selectively enable additional features for various reasons and under various conditions. For example, an additional application feature can be enabled in exchange for payment of an additional licensing fee to the provider of the software. Once enabled, an additional application feature can be used in a manner similar to which the software as a whole is used. Enabling an application feature does not allow users to modify the application feature.

To enable an additional application feature of a device, the administrator can cause the computer connected to the device to contact (via the Internet) a server operated by the provider of the software. The server can provide a web-based or similar user interface through which the administrator can control the interaction with the server. Such a server is commonly referred to as a licensing portal. Public key cryptography is commonly used in such a transaction. More specifically, in response to the administrator initiating a request to enable a feature, the device generates a key pair, i.e., the device's public key and the device's corresponding private key. The device also has the licensing portal's public key. Using the licensing portal's public key, the device encrypts the device's public key along with other information, such as information identifying the device and the application feature to be enabled, and transmits the information in the form of an encrypted message to the licensing portal. The licensing portal decrypts the received message using the licensing portal's private key. The licensing portal confirms that all conditions for enabling the application feature have been met, such as, for example, receipt of payment. If all conditions have been met, then using the device's public key, which the licensing portal received in the encrypted message, the licensing portal encrypts an enable code along with other information, such as information regarding the license or the application feature. Information regarding the license may include a date on which the license expires. The licensing portal transmits this information in the form of an encrypted message to the device. The device decrypts the received message using the device's private key. The device then uses the enable code, which the device received in the encrypted message, to enable or unlock the application feature. As the enable code is itself a type of cryptographic key, the enable code is commonly referred to as a license key.

A person who requests that an additional application feature be enabled in the manner described above generally has an administrator or super-user level of privilege. As well understood in the art, a hierarchical privilege-based authentication system is commonly employed in computing systems to restrict a subset of users from accessing a subset of features (or conversely, to grant a subset of users access to a subset of features). For example, access to operating system features, such as configuration data files, is generally restricted to users having a higher privilege level, which may be referred to as administrator level, super-user level, or root level, while access to (i.e., the privilege to use) application software is generally granted to users of all privilege levels. An administrator or super-user may be privileged to set system parameters in configuration data files used by the operating system or other low-level software. The lowest and therefore most security-sensitive level of software on a device is commonly referred to as core or root-level. Even an administrator or super-user may not have access to all root-level software (features). Indeed, administrators or other persons having the highest level of privilege afforded by the hierarchical privileged-based authentication system are generally not even aware of the existence of all root-level features, as some root-level features are generally maintained confidential by the manufacturer of the device.

Device manufacturers generally recognize that occasionally a need arises for certain engineering or repair personnel to modify certain root-level features of the device that even administrators or other persons having the highest level of privilege in the hierarchy may be restricted from modifying by the hierarchical privilege-based authentication system. For this reason, the device may include an engineering-level or technical support-level access system, which exists in the device separate and apart from the hierarchical privilege-based authentication system. Users of the device, including administrators or super-users, are generally not even aware of the existence of such a separate engineering-level or technical support-level access system, as it is itself a core or root-level feature maintained confidential by the device manufacturer. For the foregoing reasons, such a separate engineering-level or technical support-level access system is sometimes colloquially referred to as a “backdoor.” To gain backdoor access, a person may be required to correctly perform a sequence of acts, which may include entering a username and password.

### SUMMARY

Embodiments of the invention relate to securing root-level access to a device using a server remotely connected to the device.

In an exemplary method, the device generates a random key pair comprising a device public key and a device private key in response to a user request for root-level access. The device then encrypts the device public key into an encrypted request message using a server public key associated with the server. The encrypted request message is transmitted to the server. The server decrypts the encrypted request message using a server private key associated with the server. The server encrypts an enable code into an encrypted response message using the device public key. The encrypted response message is transmitted to the device. The device decrypts the encrypted response message using the device private key. The device then enables root-level access to the device in response to the enable code.

An exemplary device includes a processing system having one or more processors and memories. The processing system is configured to perform the following method. The device generates a random key pair comprising a device public key and a device private key in response to a user request for root-level access. The device then encrypts the device public key into an encrypted request message using a server public key associated with the server. The encrypted request message is transmitted to the server. When the device receives a response in the form of an encrypted response message, the device decrypts the encrypted response message using the device private key. The device then enables root-level access to the device in response to the enable code.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 illustrates an exemplary system for securing root-level access to a device, in accordance with an exemplary embodiment of the invention.

FIG. 2 is a block diagram of an exemplary device, in accordance with an exemplary embodiment of the invention.

FIG. 3 is a flow diagram illustrating an exemplary method for securing root-level access to a device, in accordance with an exemplary embodiment of the invention.

### DETAILED DESCRIPTION

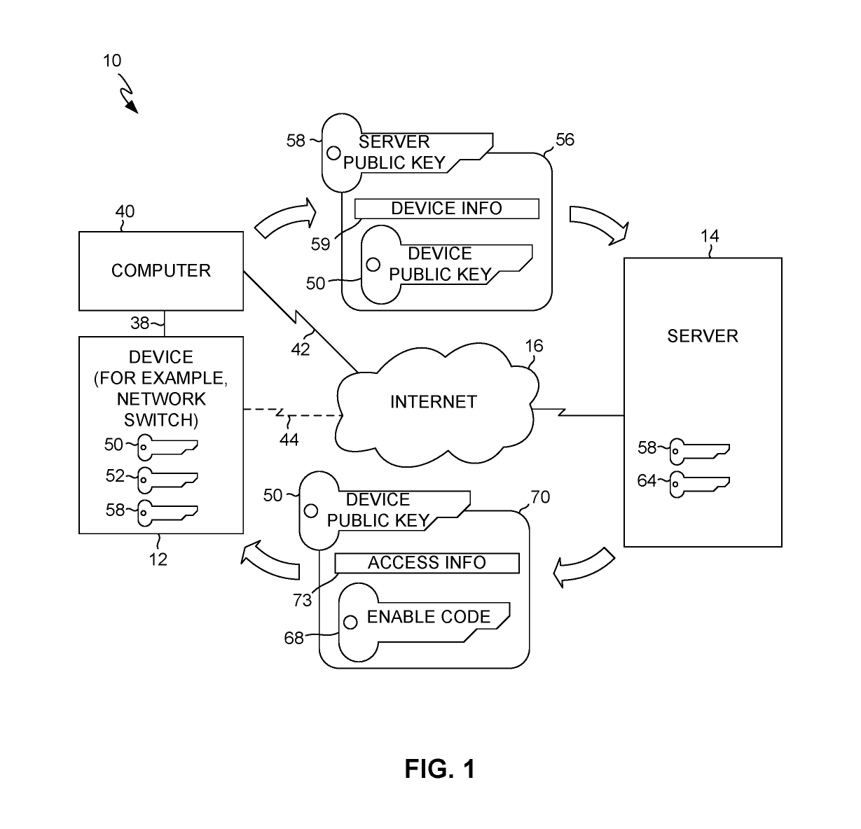

As illustrated in FIG. 1, in an illustrative or exemplary embodiment of the invention, a system 10 includes a network switch 12, such as an Ethernet switch, or other network infrastructure device, and a server 14. In the exemplary embodiment, network switch 12 and server 14 are configured to communicate via the Internet 16. However, in other embodiments network switch 12 or other such device may not be configured to communicate via an Internet connection. Although the type of network infrastructure device in the exemplary embodiment is a switch, and the network in which network switch 12 is included is an Ethernet local area network (LAN), in other embodiments such a network infrastructure device and its network can be of any other types, such as, for example, a passive optical network. In such other embodiments, the network infrastructure device can comprise, for example: a router, a gateway, a firewall, a server, a wireless access point, a multiplexer, or a passive optical network terminal. Although not shown for purposes of clarity, network switch 12 can be interconnected with other such network infrastructure devices in the LAN, as well as with client devices such as, for example, computers, printers, Internet protocol telephones, etc. As used herein, the term “network infrastructure device” refers to a device having one or more network ports connectable to network devices and configured to control one or more aspects of the communication of messages among its network ports when the network infrastructure device is operating as part of a data communication network. The remainder of FIG. 1 is described below with regard to an exemplary method of operation.

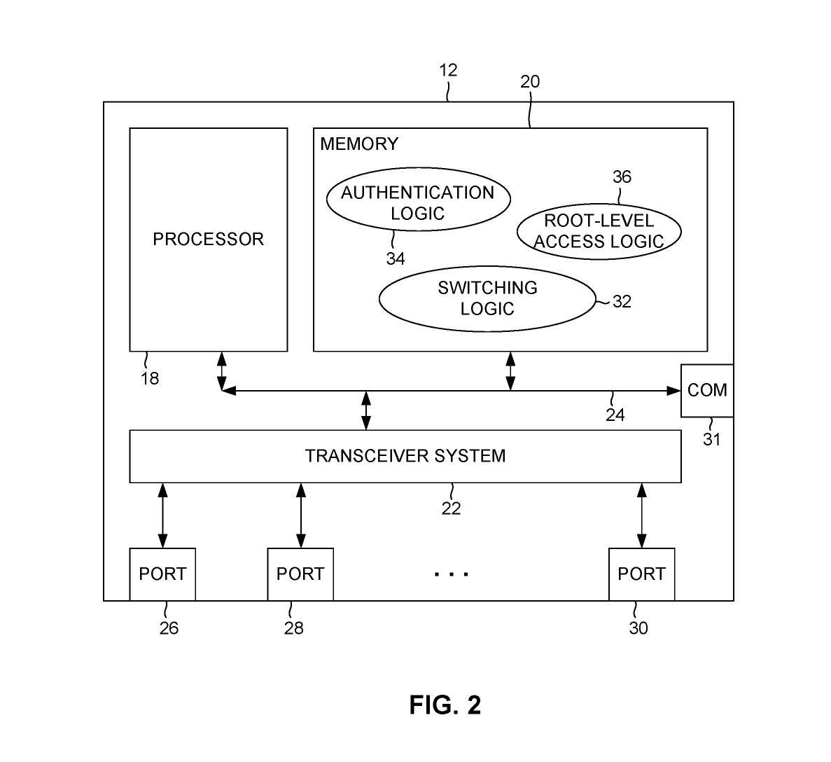

As illustrated in FIG. 2, network switch 12 includes at least one processor 18, at least one memory 20, a transceiver system 22 interconnected by a communication bus system 24, and a plurality of ports 26, 28, 30, etc. Ports 26, 28, 30, etc., may also be referred to as “physical ports,” as each comprises a jack or similar electrical signal connector to which a plug or other mating electrical signal connector can be mechanically and electrically mated. In this manner, network switch 12 can be interconnected by Ethernet cables with other such network infrastructure devices and with client devices. Although only ports 26, 28, 30, etc., are shown, network switch 12 can have any number of ports, with other ports not shown for purposes of clarity being indicated by the ellipsis symbol (“ . . . ”). Network switch 12 also includes an external communication (COM) port 31.

In the exemplary embodiment, network switch 12 is configured with processing logic that can include switching logic 32, hierarchical privilege-based authentication logic 34, and root-level access logic 36. Ports 26, 28, 30, etc., are coupled via transceiver system 22 to a processing system defined by memory 20 and processor 18 as programmed or configured by software (or firmware, etc.). The processing logic represents the processing system's configuration defined by a corresponding portion of such software or firmware. The contribution of root-level access logic 36 to the operation of network switch 12 is described below with regard to an exemplary method of operation. Hierarchical privilege-based authentication logic 34 contributes to network switch 12 providing a conventional hierarchical privilege-based authentication system to grant access at various privilege levels to various users based on user names and passwords. Such an authentication system provides security, which can include restricting users from modifying and otherwise accessing root-level software on network switch 12. The hierarchical privilege-based authentication system can, for example, be configured to restrict all users, including super-users or users having the highest level of privilege, from accessing root-level software on network switch 12. Alternatively, in other embodiments such a hierarchical privilege-based authentication system can be configured to allow some users, such as users having the highest level of privilege, to access root-level software on network switch 12. In some embodiments, such a network switch or other device may not include such an authentication system.

Switching logic 32 contributes to the operation of network switch 12 in the manner characteristic of a conventional Ethernet switch. It should be understood that except as may be otherwise described herein, network switch 12 is configured to operate not only in the manner described herein but also in the manner characteristic of a conventional Ethernet switch, routing traffic (i.e., data packets) among ports 26, 28, 30, etc. As this packet switching function, which characterizes network switch 12 as an Ethernet switch, is well understood in the art, it is not described in further detail herein. In other embodiments (not shown), in which the network infrastructure device is not a switch but rather of some other type, such a network infrastructure device is configured to operate not only in the manner described herein but also in the manner characteristic of a conventional network infrastructure device of its type.

Although switching logic 32, hierarchical privilege-based authentication logic 34, and root-level access logic 36 are shown in FIG. 2 in a conceptual manner as stored in or residing in memory 20, persons skilled in the art understand that such logic elements arise through the operation of processor 18 in accordance with conventional computing device principles. That is, software or firmware contributes to programming or configuring the processing system to be characterized by such logic elements. Although memory 20 is depicted in FIG. 2 as a single or unitary element for purposes of clarity, memory 20 can be of any suitable type and can have any suitable structure, such as one or more modules, chips, etc. Memory 20 can be of a non-volatile type, such as flash memory. Likewise, although processor 18 is depicted in FIG. 2 as a single or unitary element for purposes of clarity, processor 18 can be of any suitable type and can have any suitable structure, such as one or more modules, chips, etc. For example, processor 18 can comprise one or more microprocessors or microcontrollers. Some or all of the foregoing processing system elements can be provided in, for example, an application-specific integrated circuit (ASIC) or other integrated digital device. It should be understood that the combination of memory 20 and the above-referenced logic elements or software, firmware, instructions, etc., underlying the logic elements, as stored in memory 20 in non-transitory computer-readable form, defines a “computer program product” as that term is understood in the patent lexicon. In view of the descriptions herein, persons skilled in the art will readily be capable of providing suitable software or firmware or otherwise configuring network switch 12 to operate in the manner described. Also, although the effect of each of the above-referenced logic elements is described herein, it should be understood that the effect may result from contributions of two or more logic elements in concert, or from contributions of the logic elements and conventional switch logic elements or other software, hardware, or network elements that are not shown for purposes of clarity.

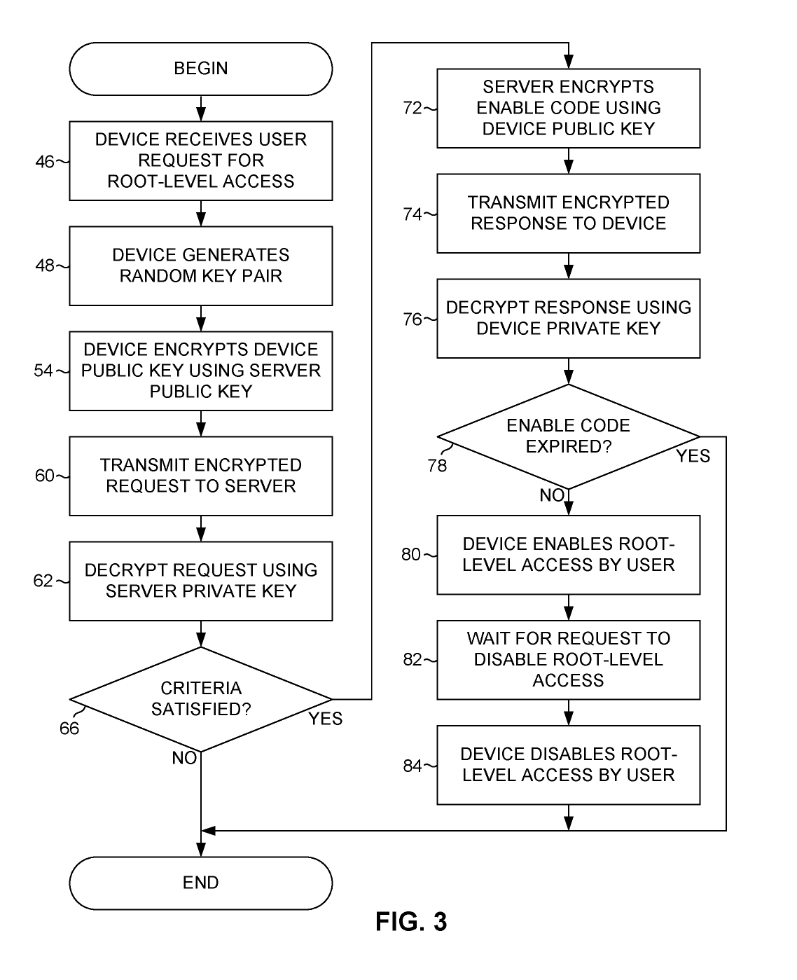

The flow diagram of FIG. 3 illustrates an exemplary method of operation of system 10 (FIG. 1). In the exemplary embodiment, the method can be performed whenever it is desired to allow a person to modify one or more root-level features of network switch 12. In other embodiments, the method can be performed at any other suitable time and under any other suitable conditions. The method may be performed while network switch 12 is not interconnected with other network infrastructure devices in the network, i.e., while network switch 12 is not operational in the manner characteristic of a conventional Ethernet switch.

A person who desires to request access to root-level features of network switch 12 can connect a suitable cable 38 between network switch 12 and a computer 40 (FIG. 1), such as a laptop computer. For example, cable 38 can be an Ethernet cable connected between one of ports 26, 28, 30, etc., of network switch 12 and an Ethernet port of computer 40. Alternatively, for example, cable 38 can be a Universal Serial Bus (USB) cable connected to a USB-to-serial adapter or dongle plugged into a USB port of computer 40 (since laptop computers commonly lack a serial port compatible with COM port 31 of network switch 12). As described below, computer 40 serves as an administrator console or user interface through which the person can interact with network switch 12 as well as log in to a portal (e.g., web site) on server 14. Although not shown for purposes of clarity, computer 40 is configured with administrator console software. Note in FIG. 1 that computer 40 has a conventional Internet connection 42. Internet connection 42 is shown in generalized form in FIG. 1 for purposes of clarity, but may include one or more wireless and wired connections, and may be via one or more intermediary networks (not shown), such as an Internet service provider network.

Network switch 12 also can have an Internet connection 44 with Internet 16, though Internet connection 44 need not exist or be operational at the time the exemplary method described with regard to FIG. 3 is performed. Rather, Internet connection 42 can serve as the connection for Internet communications to and from network switch 12, with computer 40 passing communicated information to and from network switch 12.

In the exemplary embodiment, using computer 40, the person initially can perform at least some conventional configuration procedures on network switch 12 of the type commonly performed by network administrators. For example, the person can load configuration files from computer 40 into network switch 12. The person can also cause certain configuration information to be transferred from server 14 to network switch 12 via the Internet 16. Such conventional configuration procedures can involve the user logging in to the above-referenced portal on server 14 (e.g., by providing a correct user name and password to server 14). Alternatively, or in addition, such conventional configuration procedures can involve the user logging in to network switch 12 under control of hierarchical privileged-based authentication logic 34. In addition to these conventional configuration procedures or other actions performed using computer 40, the person also can input a request to the portal for root-level access to network switch 12. Such root-level access to network switch 12 can be referred to as “backdoor” access, in contrast with “front door” access to network switch 12 via hierarchical privileged-based authentication logic 34. Although in the exemplary embodiment network switch 12 provides both front door access via hierarchical privileged-based authentication logic 34 in a conventional manner and backdoor access via root-level access logic 36 in the manner described herein, in other embodiments such a device may provide only root-level access in the manner described herein.

Referring again to the flow diagram of FIG. 3, as indicated by block 46, network switch 12 (the “device”) receives a notification of the above-referenced user request for root-level access from computer 40. As indicated by block 48, in response to this notification or request for access, network switch 12 generates a random key pair, comprising a device public key 50 and a device private key 52 (FIG. 1). As the algorithms and other aspects by which such random key pair generation can be performed are well understood in the art, such details are not described herein. As well understood in the art, randomization can be promoted by using unpredictable information as inputs to the key generation algorithm, such as, for example, the time of day, the number of seconds network switch 12 has been powered on, etc.

As indicated by block 54, network switch 12 then encrypts device public key 50 into an encrypted request message 56 (FIG. 1) using a server public key 58 associated with server 14. Additional device information 59 (FIG. 1) also can be encrypted along with device public key 50. Server public key 58 can be installed in network switch 12 at any suitable time, such as, for example, at the time of manufacture. It is contemplated in the exemplary embodiment that network switch 12 and server 14 are associated with the same manufacturer or other entity, and that such an entity can ensure server public key 58 is present in both server 14 and network switch 12.

As indicated by block 60, encrypted request message 56 is then transmitted to server 14 via the Internet 16. For example, the person operating computer 40 can include encrypted request message 56 in an e-mail message (not shown) to server 14. As indicated by block 62, server 14 decrypts encrypted request message 56 using a server private key 64 (FIG. 1) associated with server 14. It can be noted that the decrypted contents of encrypted request message 56 include device public key 50 and additional device information 59.

As indicated by block 66, server 14 then determines whether the decrypted contents satisfy one or more criteria or conditions. For example, server 14 can determine whether the additional device information 59 includes information properly identifying network switch 12. In response to server 14 determining (block 66) that the decrypted contents do not satisfy the criteria, server 14 does not respond to the request. Alternatively, in other embodiments (not shown) server 14 can send a message to network switch 12 if it is determined that the decrypted contents do not satisfy the criteria, notifying the user that the request is denied. In response to server 14 determining (block 66) that the decrypted contents satisfy the criteria, server 14 encrypts an enable code 68 into an encrypted response message 70 (FIG. 1) using device public key 50, as indicated by block 72. Access information 73 (FIG. 1) also can be encrypted along with enable code 68. Access information 73 can include a timestamp and other information.

As indicated by block 74, encrypted response message 70 is then transmitted from server 14 to network switch 12 via the Internet 16. For example, server 14 can include encrypted request response message 70 in an e-mail message (not shown) to computer 40. Personnel operating server 14 can control the steps described above with regard to blocks 62, 72, 74, etc. As indicated by block 76, network switch 12 decrypts encrypted response message 70 using device private key 52 (FIG. 1). The person operating computer 40 can control the operation of network switch 12 to effect the steps described herein with regard to blocks 48, 54, 60, 76, etc. It can be noted that the decrypted contents of encrypted response message 70 include enable code 68 and access information 73. As indicated by block 78, network switch 12 can determine whether the time at which it receives and decrypts encrypted response message 70 is more than a threshold amount of time later than the time indicated by the timestamp. When the threshold amount of time elapses after the time indicated by the timestamp, enable code 68 is expired. Thus, block 78 indicates network switch 12 determining whether enable code 68 is expired. Although not shown for purposes of clarity, network switch 12 can thereafter at intervals determine whether enable code 68 is expired, and can disable root-level access when enable code 68 expires.

As indicated by block 80, in response to network switch 12 determining that enable code 68 is not expired, network switch 12 enables root-level access to network device 12 using (i.e., in response to) the enable code. Note that enable code 68 can be a type of key, and that network switch 12 can enable root-level access to network device 12 using cryptographic methods. Such cryptographic methods can be similar to those conventionally used to enable an application-level feature for access by a user. Although in the exemplary embodiment network switch 12 does not enable root-level access unless it determines enable code 68 is not expired, in other embodiments such an enable code may have no expiration. Access information 73 can also include information that computer 40 displays to inform the user.

While root-level access to network device 12 remains enabled, network switch 12 does not restrict the user from modifying and otherwise accessing root-level software on network switch 12. For example, the user can modify software that corresponds to switching logic 32 (FIG. 1). Enabling root-level access can bypass hierarchical privilege-based authentication system logic 34, which can otherwise restrict users from modifying and otherwise accessing root-level software on network device 12.

As indicated by block 82, network switch 12 can remain in a state in which root-level access is enabled until such time as network switch 12 receives a request to disable root-level access (or until enable code 68 expires). Network switch 12 can receive such a request to disable root-level access in the same manner in which it receives (block 46) a request to enable root-level access, i.e., from computer 40, under control of a user. As indicated by block 84, in response to receiving such a request to disable root-level access, network switch 12 disables root-level access. The request to disable root-level access can correspond to the user terminating the communication connection between computer 40 and network switch 12. Alternatively, or in addition, network switch 12 can disable root-level access when it determines computer 40 is no longer connected to network switch 12.

While root-level access to network switch 12 remains disabled, network switch 12 restricts users from modifying and otherwise accessing root-level software on network switch 12. Once network switch 12 disables root-level access in response to a request to disable root-level access (block 84) or expiration of enable code 68, network switch 12 thereafter remains unresponsive to again receiving enable code 68 from server 14. For example, once network switch 12 disables root-level access, network switch 12 can delete the key pair comprising device public key 50 and device private key 52. At such time as another request for root-level access may be received (block 46), network switch 12 generates (block 48) a new key pair.

Although not shown in FIG. 3 for purposes of clarity, after network switch 12 has been configured, which can include configuration procedures conducted through the above-described root-level or backdoor access, network switch 12 can be connected to other network devices (not shown) and operated in the manner characteristic of a conventional Ethernet switch.

One or more illustrative or exemplary embodiments of the invention have been described above. However, it is to be understood that the invention is defined by the appended claims and is not limited to the specific embodiments described.

1. A method for securing access to a device using a server remotely connected to the device, comprising:
generating, by the device, a unique random key pair comprising a device public key and a device private key in response to a user request for root-level access;
encrypting, by the device, the device public key into an encrypted request message using a server public key;
transmitting the encrypted request message to the server;
decrypting, by the server, the encrypted request message using a server private key;
encrypting, by the server, an enable code into an encrypted response message using the device public key;
transmitting the encrypted response message to the device;
decrypting, by the device, the encrypted response message using the device private key;
enabling, by the device, root-level access to the device using the enable code alone; and
enabling access to the device through a hierarchical, privilege-based, password-based authentication system of the device.

2. (canceled)

3. The method of claim 1, wherein the enable code has an expiration time interval, and the method further comprises:
determining, by the device, whether the expiration time interval has elapsed; and
disabling, by the device, root-level access to the device after determining the expiration time interval has elapsed, wherein the device thereafter remains unresponsive to the enable code received from the server.

4. The method of claim 1, further comprising:
receiving, by the device, a user request for disabling root-level access; and
disabling, by the device, root-level access to the device in response to the user request for disabling root-level access, wherein the device thereafter remains unresponsive to the enable code received from the server.

5. The method of claim 1, wherein the device comprises a network infrastructure device.

6. The method of claim 5, wherein the network infrastructure device comprises one of a switch, a router, a gateway, a firewall, a server, a wireless access point, a multiplexer, and a passive optical network terminal.

7. The method of claim 5, further comprising establishing a wired communication link between the network infrastructure device and a computer, and wherein the network infrastructure device receives the user request for root-level access through the computer.

8. A device, comprising:
a processing system having one or more processors and memories storing computer-executable instructions that when executed by the processing system perform a method comprising:
generating a unique random key pair comprising a device public key and a device private key in response to a user request for root-level access;
encrypting the device public key into an encrypted request message using a server public key;
transmitting the encrypted request message to a server;
receiving an encrypted response message including an enable code from the server;
decrypting the encrypted response message using the device private key;
enabling root-level access to the device using the enable code alone; and
providing a hierarchical, privilege-based, password-based authentication system for the device.

9. (canceled)

10. The device of claim 8, wherein the processing system is further configured to disable access to the feature after determining an expiration time interval of the enable code has elapsed, wherein the device thereafter remains unresponsive to the enable code received from the server.

11. The device of claim 8, wherein the method with which the processing system is configured further comprises:
receiving a user request for disabling root-level access; and
disabling root-level access to the device in response to the user request for disabling root-level access, wherein the device thereafter remains unresponsive to the enable code received from the server.

12. The device of claim 8, wherein the device comprises a network infrastructure device.

13. The device of claim 12, wherein the network infrastructure device comprises one of a switch, a router, a gateway, a firewall, a server, a wireless access point, a multiplexer, and a passive optical network terminal.

14. The device of claim 12, further comprising a wired communication link between the network infrastructure device and a computer, and wherein the processing system is configured to receive the user request for root-level access through the computer.

15. A computer program product for securing access to a device using a server remotely connected to the device, the computer program product comprising a non-transitory computer-readable medium having instructions stored thereon in computer-readable form that when executed by a processing system of the device causes the device to control a method comprising:
generating a unique random key pair comprising a device public key and a device private key in response to a user request for root-level access;
encrypting the device public key into an encrypted request message using a server public key;
transmitting the encrypted request message to a server;
receiving an encrypted response message including an enable code from the server;
decrypting the encrypted response message using the device private key; and
enabling root-level access to the device using the enable code alone; and
enabling access to the device through a hierarchical, privilege-based, password-based authentication system of the device.

16. (canceled)

17. The computer program product of claim 15, wherein the enable code has an expiration time interval, and the method further comprises:
determining whether the expiration time interval has elapsed; and
disabling root-level access to the device after determining the expiration time interval has elapsed, wherein the device thereafter remains unresponsive to the enable code received from the server.

18. The computer program product of claim 15, further comprising:
receiving a user request for disabling root-level access; and
disabling root-level access to the device in response to the user request for disabling root-level access, wherein the device thereafter remains unresponsive to the enable code received from the server.

19. The computer program product device of claim 15, wherein the device comprises a network infrastructure device.

20. The computer program product of claim 19, wherein the network infrastructure device comprises one of a switch, a router, a gateway, a firewall, a server, a wireless access point, a multiplexer, and a passive optical network terminal.
